(19) United States
(12) Patent Application Publication
(10) Pub. No.: US 2006/0046794 A1
(43) Pub. Date: Mar. 2, 2006

(54) System and method for transmitting barrier control signals from a wireless device

(75) Inventors: William Scherschel, Wheaton, IL (US); Harold J. Morrow, Chicago, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 10/931,172

(22) Filed: Aug. 31, 2004

(51) Int. Cl. H04M 1/00

(52) U.S. Cl. 455/575.1; 455/73

(57) ABSTRACT

A communication method and system for transmitting and receiving wireless communications and controlling a barrier operator includes a wireless communication portion for providing wireless communications between a user at a communication device and a target communication device. The method and system also uses an accessory portion connected to but functionally separate from the wireless communication portion. The accessory portion includes a barrier control transmitter. The barrier control transmitter provides a signal to activate a barrier operator. In some examples, the transmitter may be incorporated into the wireless communication portion.

### BACKGROUND OF THE INVENTION

Transmitters are used in a variety of applications in which the wireless operation of a device is desired. For example, most garage door openers, gate operators, and rolling shutter systems utilize transmitters to operate the movable barrier associated with the operator, (e.g., to operate the door, gate or shutter). In these cases, a user may carry a portable barrier control transmitter with him or her and actuate the transmitter to operate the movable barrier.

Generally, the barrier control transmitter transmits one or more RF security codes in response to user initiation such as pressing a button. The RF transmission is performed at a frequency designed to barrier movement operator systems. The security codes being transmitted may be preassigned in manufacture or may be user changeable. A receiver in the barrier mount operator may be trained for use with a limited number of barrier control transmitters in a learn mode practiced by the receiver.

Cellular phones, pagers, and other mobile wireless devices are also in common place usage today. The devices are carried by users and include a variety of functions including the ability to communicate with other users, the ability to access email, and the ability to access the Internet.

Because many consumers desire to use both transmitters and mobile wireless devices, some prior wireless devices place the barrier control function into the wireless communication electronics. That is, these prior systems are comprised of shared electrical and software components that both perform wireless communication functions and the barrier control functions.

Although these previous systems eliminate the need to carry separate transmitters and mobile wireless devices, the sharing of components between the wireless and barrier control units creates problems in some of these previous systems. For example, it is often expensive to insert the barrier transmission functionality into the wireless communication electronics due to the complexity of the wireless communication electronics. In addition, if the barrier transmission technology were to change, then it may necessitate modifying a substantial amount of the components responsible for the wireless communication functionality. Thus, even a small change in the barrier transmission electronics might necessitate large changes in the combined electronics of the system.

Still another problem with these previous systems is that the addition of the barrier operator transmitter must be made by the phone manufacturer. Any new change or feature that is utilized in the barrier operator transmitter must be coordinated with the wireless device manufacturer. In this case, the user will not enjoy the flexibility to replace or modify the features of a transmitter, since these actions must usually be performed when the unit is made.

### SUMMARY OF THE INVENTION

A system and method for transmitting and receiving wireless communications and controlling a barrier operator has separate wireless communication and barrier control transmitter portions. The components performing the barrier control function and the wireless communication function are physically associated with each other. However, the components are also separate and distinct from each other allowing for a system that is easily modifiable, less expensive than previous systems, and customizable for a particular user.

In one example, a system includes a wireless communication portion. This wireless communication portion may be, for example, a cellular telephone or walkie-talkie that includes elements for providing wireless communications between a user at the system and other users that may be connected to the system. An accessory portion, for example, a jacket or cover, is associated with the wireless communication portion. The accessory portion includes a barrier control transmitter and the transmitter provides a signal that actuates a barrier operator. The wireless communication portion and the barrier control transmitter within the accessory portion are functionally separate and distinct.

In other embodiments, the barrier control transmitter may be integrated into portions of the wireless communication device. For example, the barrier control transmitter may be integrated into the battery cover of the wireless communication device or into the skin of the wireless communication device. As in the case where the barrier control transmitter is associated with an accessory, the barrier control transmitter and the wireless communication device are separate and distinct.

Thus, the present approach provides a system whereby the hardware and software components are not combined resulting in a less complex and, therefore, less expensive system. In addition, changes or upgrades to either the wireless portion or the barrier control portion are easy to make since a modification in one portion does not require changes to the other portion. Still another advantage is that a user can make the upgrades rather than requiring the changes be done at the factory. This allows the user to have the flexibility to incorporate whatever changes or modifications they desire in their systems. In the present approach, the user may also select an accessory portion having whatever functionality they desire resulting in a system that is customized to fit the exact needs of the user.

### BRIEF DESCRIPTION OF THE DRAWINGS

FIG. 1 is a perspective view of a movable barrier operator using a transmitter according to the present invention;

FIG. 2 is a block diagram of a transmitter with an attachment according to the present invention;

FIG. 3 is a block diagram of a transmitter according to the present invention;

FIGS. 4a and 4b are views of a transmitter with an attachment according to the present invention;

FIGS. 5a and 5b are views of a transmitter located on the battery cover of a wireless communication device according to the present invention;

FIGS. 6a and 6b are schematic diagrams of one example of a transmitter according to the present invention; and

FIGS. 7a and 7b are views of the transmitter of FIGS. 6a and 6b in combination with an accessory according to the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful in a commercially feasible embodiment are often not depicted in order to facilitate a less obstructed view of the various embodiments of the present invention.

While the invention will be described in connection with a preferred embodiment, it will be understood that it is not intended to limit the invention to that embodiment. On the contrary, it is intended to cover all alternatives, modifications and equivalents as may be included within the spirit and scope of the invention as defined by the appended claims.

### DETAILED DESCRIPTION OF THE PREFERRED EMBODIMENTS

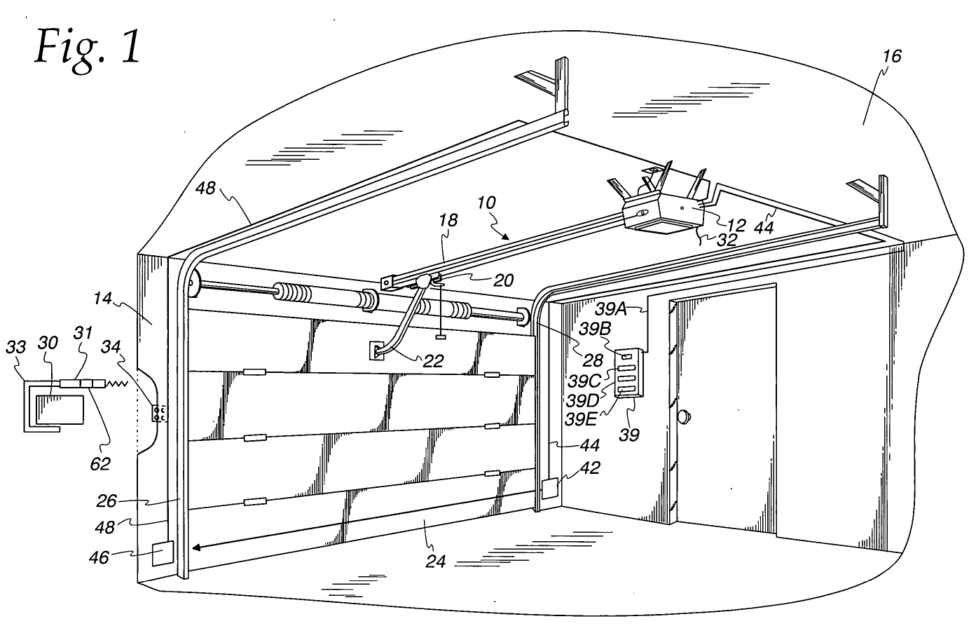

Referring now to the drawings and especially to FIG. 1, a movable barrier operator embodying the present invention is generally shown therein and identified by reference numeral 10. The movable barrier operator 10 includes a head unit 12 mounted within a garage 14 and is employed for controlling the opening and closing of garage 14. More specifically, the head unit 12 is mounted to the ceiling 16 of the garage 14 and includes a rail 18 extending therefrom with a releasable trolley 20 attached having an arm 22 extending to a multiple paneled garage door 24 positioned for movement along a pair of door rails 26 and 28. The movable barrier operator 10 transfers the garage door 24 between the closed position illustrated in FIG. 1 and an open or raised position, allowing access to and from the garage 14.

The system includes a wireless communication device 30, which has an associated barrier control transmitter 31. The barrier control transmitter 31 is adapted to send signals to an antenna 32 positioned on the head unit 12 and coupled to a receiver located within the head unit 12. An external control pad 34 is positioned on the outside of the garage having a plurality of buttons thereon and communicates via radio frequency transmission with the antenna 32 of the head unit 12. The wireless communication device may be a cellular telephone, walkie talkie, pager, personal digital assistant (PDA), personal laptop computer, or the like. The barrier control transmitter 31 includes a button 62 to actuate the barrier control transmitter 31.

As described in greater detail below, the barrier control transmitter 31 may be integrated or associated with an accessory 33. Alternatively, the transmitter 31 may be integrated with portions of the wireless communication device 30. In either case, the transmitter 31 is separate and distinct from the circuitry within the wireless communication device 30 that performs wireless communication functions.

The barrier control transmitter 31 associated with the wireless communication device 30 and the control pad 34 is capable of transmitting a plurality of different codes at a plurality of different frequencies, as will be appreciated in more detail hereinafter. A switch module 39 is mounted on a wall of the garage. The switch module 39 is connected to the head unit by a pair of wires 39a. The switch module 39 includes a learn switch 39b, a light switch 39c, a lock switch 39d and a command switch 39e.

An optical emitter 42 and an optical detector 46 are coupled to the head unit 12 by a pair of wires 44 and 48, respectively. The emitter 42 and detector 46 are used to satisfy the requirements of Underwriter's Laboratories, the Consumer Product Safety Commission and the like which require that garage door operators sold in the United States must have secondary safety system in addition to the primary protection. The primary protection measures the force and reverses and opens the door when the force value is above the threshold in order to prevent damage to property and injury to persons. Limits, a conventional pass point detector or absolute positioning detector may also be used to indicate door position to the controller.

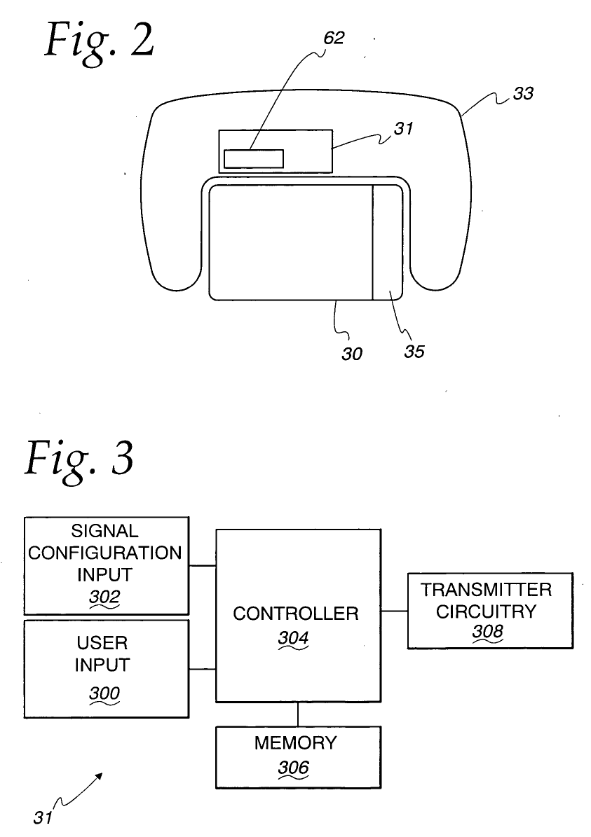

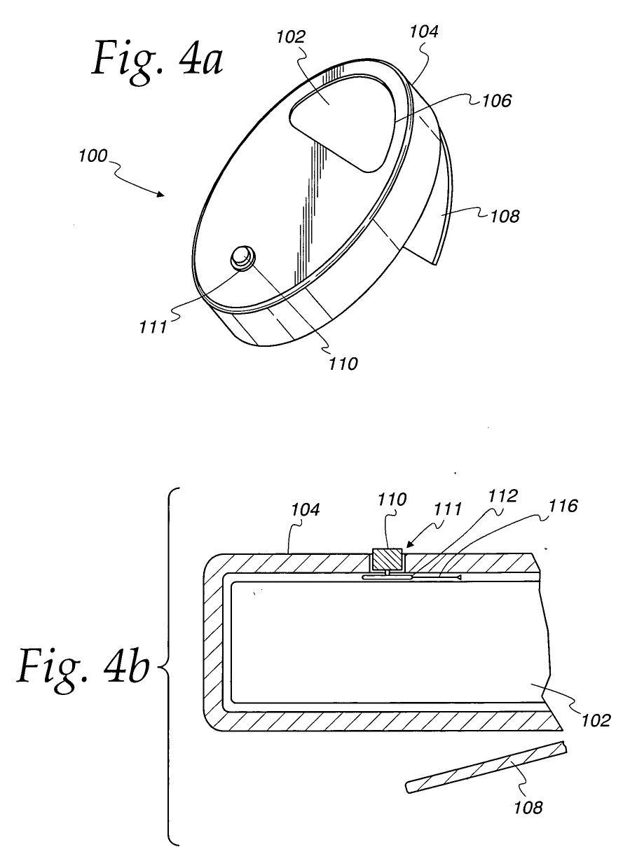

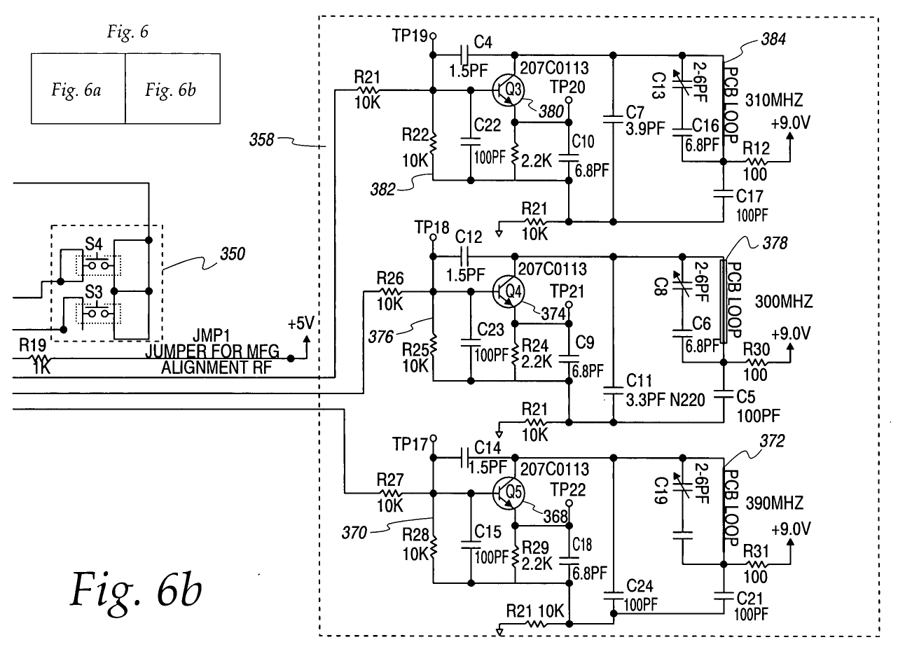

Referring now to FIG. 2, one example of a system including the wireless communication device 30 and the barrier control transmitter 31 is described. The wireless communication device 30 is associated with the accessory portion 33. The accessory portion 33 includes the barrier control transmitter 31 (described in greater detail with respect to FIGS. 3 and 6). The wireless communication device 30 provides mobile communication services and is a device such as a cellular telephone or walkie talkie.

The accessory portion 33 may be a replacement cover, a replacement back, a replacement battery, a jacket, or a glove. In another approach, the accessory portion 33 may be eliminated and the transmitter may be integrated into the communication portion in a manner such that transmitter is separate and distinct from the hardware and software of the communication portion 64.

In the example of FIG. 2, the barrier control transmitter 31 is attached, affixed, and or situated with or within the accessory portion 33. If the accessory portion 33 is a phone jacket or cover, the transmitter 31 may conveniently be placed or inserted into the jacket such that any user interface on the transmitter 31 extends or protrudes from the jacket. An operator may then access the interface to operate the transmitter. The transmitter 31 provides modulation, transmission, receiving and other electronically-based functions.

As shown in FIG. 2, the barrier control transmitter 31 within the accessory portion 33 is separate and distinct from the wireless communication device 30, include a wireless communication transmitter 35 in the device 30. The wireless communication transmitter 35 provides modular, transmission and receiving functions for the wireless communication device 30. That is, the barrier control transmitter 31 and its hardware and software are not shared by and operate independently from any hardware and software in the wireless communication device 30. The accessory portion 33 may be attached to the wireless communication device 30 or the accessory portion 33 may hold or contain the wireless communication device 30 (as in the example of the accessory portion being a glove).

Referring now to FIG. 3, one example of a transmitter is described. The transmitter includes a plurality of pushbutton inputs 300, a multi-position switch (or configuration switch input) 302, controller 304, memory 306, and transmitter circuitry 308. The pushbutton inputs 300 can comprise any number of pushbuttons and operate to send power to the controller 304, (indicating that a receiver actuation signal should be transmitted). The configuration switch input 302 is a multi-position switch that allows the user to select among a plurality of transmitter code modulation schemes, bit patterns, and frequencies which will be transmitted as part of the receiver actuation signal.

The controller 304 determines which pushbutton 300 has been pressed and what configuration and bit pattern has been selected by configuration input 302. The controller 304 then processes the selected information, stores the signal format settings to memory 306 and outputs data to the transmitter circuitry 308 which is responsible for transmitting a receiver actuating signal at the frequency associate with the selected signal format or configuration. For example, the controller 304 would output data to transmitter circuitry 308 if the configuration input 302 specified transmitting a 8 bit or 10 bit receiver actuation signal at 310 Megahertz (MHz). Similarly, if the configuration input 302 specified transmitting a 10 bit receiver actuation signal at 310 MHz, the controller 304 would output data to transmitter circuitry 308. The transmitter circuitry may include a multi-frequency transmitter loop or several transmitter loops each being capable of generating a receiver actuation signal at a different frequency.

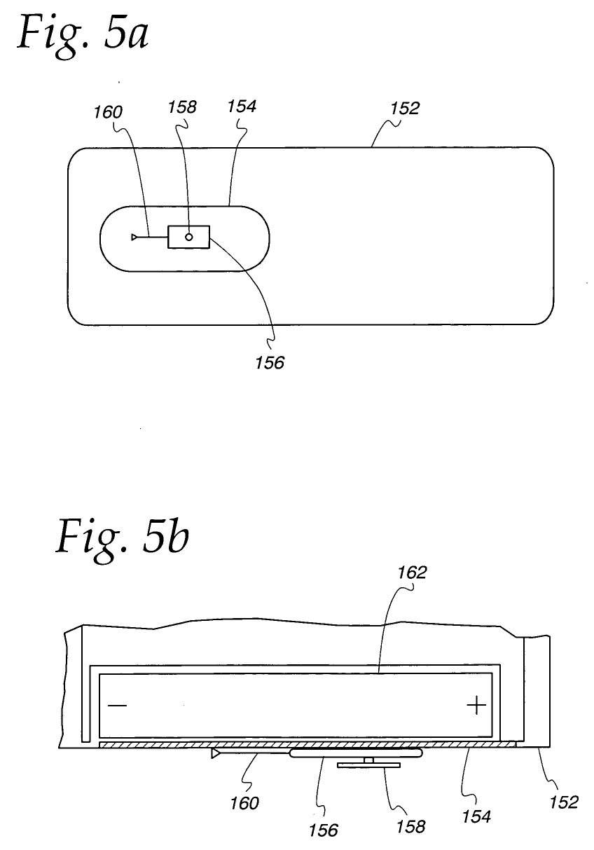

Referring now to FIGS. 4a and 4b, an example of a wireless communication device accessory associated with a transmitter is described. An arrangement 100 includes a wireless communication device holder 104 and cellular phone 102. Portions of the wireless communication device 102 are visible through a plastic window 106. The holder 104 includes a clip 108, which is used to secure the holder 104 together with the wireless communication device 102 to a person or object.

The holder 104 is a conventional wireless communication device holder or jacket in which a user places a wireless communication device. In other words, the holder 104 encloses the wireless communication device so that the wireless communication device is protected and can be conveniently secured to a person or object.

As shown in FIGS. 4a and 4b, the holder includes an opening 111 through which a button 110 protrudes. The button 110 is attached to a barrier control transmitter 112 and the barrier control transmitter 112 includes an antenna 116. When depressed, the button 110 causes a transmission signal to be formed within the transmitter 112 and to be transmitted via the antenna 116. The signal formed at the antenna 116 can then be transmitted and received by a barrier operator. As described above, the signal can then be processed and used to operate the barrier operator.

The wireless communication device 102 is enclosed by the holder 104. The barrier control transmitter 112 is attached to the inner surface of the holder 104 by an affixing agent, for instance, glue or some other adhesive. The barrier control transmitter 112 is arranged so that the button 110 is aligned through the opening 111. Although, the opening 111 is shown as being small in size, it will be realized that the opening can be of any size, or no opening may exist, to accommodate any type or size of user interface on the barrier control transmitter 112. For example, if the user interface includes more than one button, all the buttons would protrude from the opening 111 and the size of the opening would be adjusted accordingly. Alternatively, an opening 111 may not exist at all. Instead the holder may be flexible with indications of where the buttons reside, allowing activation by pressing upon the holder.

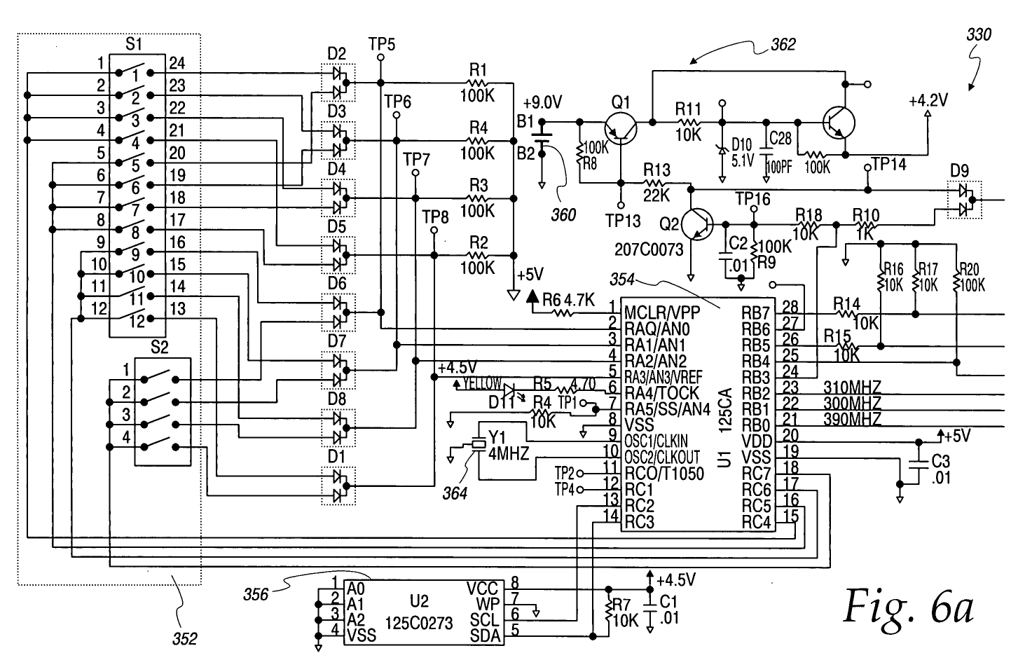

Referring now to FIGS. 5a and 5b, an example of a wireless communication device battery cover including a transmitter affixed to the top of the battery cover is described. A wireless communication device 152 includes a battery cover 154. The battery cover 154 includes a barrier control transmitter 156 that is affixed to the outside surface of the cover. The barrier control transmitter 156 includes a control button 158. The button 158 is used to actuate the transmitter 156. In turn, the barrier control transmitter 156 send a signal that actuates a barrier control operator.

The barrier control transmitter 156 is formed such that is thin and can be placed on the cover 154 with a minimum of adhesive such that the transmitter does not create a bulge. In another approach, the transmitter can be placed in the cover itself such that the button protrudes from the transmitter. When the user pushes the button 158, a signal is created in the barrier control transmitter 156 and the signal is sent via the antenna 160 to activate the barrier operator. In another example, the barrier control transmitter may include a different interface (instead of the button 158) and this interface can also be placed about the wireless communication device 152. In still another example, the barrier control transmitter is incorporated or formed with the cellular phone. The barrier control transmitter may be formed in the skin of the cellular phone or within (as opposed to on a surface) of the battery cover.

Turning now to FIG. 6, in which a schematic diagram of a transmitter embodying the present invention is shown generally at reference numeral 330. It will be realized that the transmitter described with respect to FIG. 6 is only one example of a transmitter that may be used in the present approach. In other words, the transmitter described with respect to FIG. 6 is given as an example and other examples of transmitters are possible. In addition, the functions and modes of operation described with respect to the barrier control transmitter of FIG. 6 are also only given as examples and other functions and modes of operation are possible. The transmitter 330 is separate and distinct from the components of a wireless device used to perform wireless communication functions.

The barrier control transmitter 330 includes user input 350, signal configuration input (or configuration input) 352, controller 354, memory 356 and transmitter circuitry 358. Power is supplied to the transmitter 330 via battery 360 and power circuitry 362 which regulates the voltage supply to +5 Volts (V) for pin VDD with respect to VSS of controller 354 (which may be a Microchip PIC16C63A). A 4 MHz crystal clock generator (oscillator) 364, such as a ceramic resonator, is coupled to pins CLKIN and CLKOUT to provide timing for the controller 354.

The configuration input 352 includes two multi-position DIP switches S1 and S2 which are connected to pins RA0, RA1, RA2 and RA3 of controller 354 on one side and pins RC4, RC5, RC6 and RC7 on the other. Switches S1 and S2 provide sixteen switches with which the user is able to identify the signal configuration. The controller 354 reads the multi-position switch settings by cycling pin RC7, RC6, RC5 and RC4 on one at a time. From the controller's perspective the switches are arranged in a four by four matrix with pins RA0, RA1, RA2 and RA3 making up the rows and pins RC4, RC5, RC6 and RC7 making up the columns.

Switch S2 contains four switches which are used to identify the type of transmitter that is to be emulated by the universal transmitter 330. The switches of S2 are adjusted to open or close the contacts of the DIP switch and are all connected to output pin RC7 of the controller 54. The controller 354 determines the position of each of the four switches in DIP switch S2 by driving output pin RC7 high and reading the input received on input pins RA0, RA1, RA2 and RA3. For each of the four switches in DIP switch S2 that are closed, a high input will be received on the input pin coupled to the closed switch. The settings of these switches will identify to the controller 354 which transmitter is to be emulated. In the preferred embodiment, the universal transmitter is set up to emulate eight different transmitters. These may be transmitters from Stanley, MultiCode, Linear/Moore-O-Matic, Genie and Chamberlain.

Switch S1 contains twelve switches which are used to identify the security code (or bit sequence) that is to be transmitted by the universal transmitter 330. In order to read the settings of switch S1, the twelve switches of S1 are separated into three groups with four switches in each group. The three groups of switches are connected to output pins RC6, RC5 and RC4. The controller 354 determines the position of each of the four switches in the first group of switches by driving output pin RC6 high and reading the input received on input pins RA0, RA1, RA2 and RA3. For each closed switch a high input will be received on the input pin coupled to the closed switch. The settings of these switches will identify to the controller 354 the first four digits of code that are to be transmitted by the transmitter 330. Then the controller 354 determines the position of each of the four switches in the second group of switches by driving output pin RC5 high and reading the input received on input pins RA0, RA1, RA2 and RA3. Again, for each closed switch a high input will be received on the input pin coupled to the closed switch. The settings of these switches will identify to the controller 354 the fifth through eighth digits of code that are to be transmitted by the transmitter 330. Lastly, the controller 354 determines the position of each of the four switches in the third group of switches by driving output pin RC4 high and reading the input received on input pins RA0, RA1, RA2 and RA3. A high input will be received on the input pins coupled to closed switches. The settings of these switches will identify to the controller 354 the remaining digits of code that are to be transmitted by the transmitter 330.

In order to have the controller 354 read the configuration input switch settings, the transmitter 330 must be placed in a learn mode. The transmitter 330 is placed in learn mode by depressing the user input switches 350 (e.g., momentary switches S3 and S4) down together and holding them down for a minimum of five seconds although other arrangements for entering the learn mode, such as dedicated learn mode switches could be used. When the controller 354 has entered the learn mode, it will alternate pin RA4 high and low causing bursts of current to flow through the current limiting capacitor R5 and through the yellow light emitting diode (LED) 366 making the LED 366 blink. The controller 354 will remain in learn mode for 10 seconds and will store the signal configuration settings into memory 356 once a user input 350 is depressed. Since the momentary switches S3 and S4 of the transmitter 330 are coupled to the battery 360 on one side and to pins RB5 and RB7 on the other, the controller 354 is capable of determining when a user input 350 has been depressed by polling pins RB5 and RB7 to see if either have been driven high. If either pin has been driven high, the controller 354 knows that the switch (S2 or S3) connected to the pin driven high (RB5 or RB7) has been closed. The memory location where the signal configuration settings are stored is associated with the user input that was depressed so that the controller 354 will recall the correct signal configuration every time that input is depressed. Memory 356 may consist of a serial EEPROM such as PIC16CR62.

A second signal configuration may be programmed into the transmitter 330 by placing the transmitter 330 back into learn mode, (e.g., depressing both user inputs 350 at the same time and holding for a minimum of five seconds), and selecting/depressing a user input 350 with which the new signal configuration is to be associated. Since the transmitter 330 only remains in the learn mode for ten seconds, the signal configuration settings should be made prior to placing the transmitter 330 into learn mode. By doing so, the user will only need to select the user input 350 the signal configuration settings are to be associated with while the transmitter 330 is in learn mode. In FIG. 6, a two button barrier control transmitter is provided in which one signal configuration setting can be stored for switch S3 of user input 350 and another signal configuration setting can be stored for switch S4 of user input 350. In other embodiments, additional user input switches may be provided to allow for the storing of additional signal configurations, (e.g., a three button transmitter may be provided to allow for a third signal configuration setting to be stored, a fourth button transmitter may be provided to allow for a fourth signal configuration setting to be stored, etc.).

A stored signal configuration setting may be replaced by another signal configuration setting by simply adjusting the signal configuration input 352 to the desired new signal configuration setting, placing the transmitter 330 into learn mode, and selecting the user input 350 associated with the old signal configuration setting to be replaced. This action will cause the controller 354 to store the new signal configuration settings (or the current settings of the multi-position switches S1 and S2) in place of the old signal configuration settings.

Unless the learn mode is again entered, the multi-position switch settings may be altered in any fashion without affecting how the transmitter 330 works. This is due to the fact that the signal configuration settings needed for transmitting by the transmitter 330 are retrieved from memory 356 not directly from the configuration input 352. The signal configuration input 352 simply serves as a way of getting these signal configuration settings stored into memory 356.

During normal operation (e.g., when the transmitter 330 is not in learn mode) the controller 354 is un-powered in an effort to preserve battery power and prolong battery life. The controller 354 is awakened from the un-powered state when either S3, S4 or the combination is depressed. The driving of one of the input pins RB5 and RB7 signifies to the controller that the user input 350 has been depressed. In the latter instance, the driving of both input pins RB5 and RB7 signifies to the controller 354 that the learn mode should be entered (presuming both inputs are depressed for a minimum of five seconds). If one of the user inputs 350 are depressed, the controller retrieves the signal configuration settings from the memory location associated with the depressed user input (S3 or S4) and determines what transmitter circuitry 358 the signal should be outputted to for transmission.

In response to the detection of a depressed user input 350 associated with a code to be transmitted at 390 MHZ, the controller 354 will bias transistor 368 on via pin RB0 to modulate oscillator circuit 370 and transmit the signal specified by the stored signal configuration settings (or stored signal). Transistor 368 and oscillator circuit 370 enable the RF transmission of the stored signal at approximately 390 MHZ via the antenna 372, herein a printed circuit board (PCB) loop antenna. When the selected signal configuration settings indicate that the stored signal is to be transmitted at 300 MHZ, the controller 354 will bias transistor 374 on via pin RB1 to modulate oscillator circuit 376 and transmit the stored signal. Transistor 374 and oscillator circuit 376 enable the RF transmission of the stored signal at approximately 300 MHZ via the antenna 378. When the selected signal configuration settings indicate that the stored signal is to be transmitted at 310 MHZ the controller 354 will bias transistor 380 on via pin RB2 to modulate oscillator circuit 382 and transmit the stored signal. As with the other transmitter circuits, transistor 380 and oscillator circuit 382 enable the RF transmission of the stored signal at approximately 310 MHZ via the antenna 384. When an input 350 has been depressed and the transmitter is transmitting the stored signal, the controller 354 will set pin RA4 high causing current to flow through the current limiting resistor R5 and through the yellow light emitting diode (LED) 366 causing the diode to remain steadily lit thereby indicated to the user that the transmission request has been received and that the transmitter is operating.

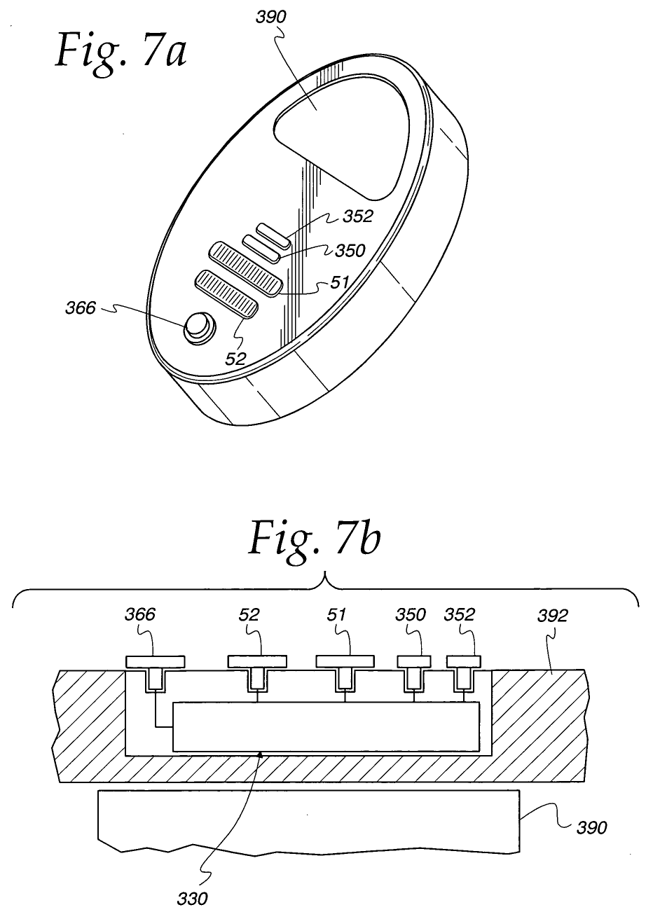

Referring now to FIGS. 7a and b, one example of an accessory incorporating the barrier control transmitter of FIG. 6 is described. The barrier control transmitter 330 including the switches S1 and S2, the LED 366, and user inputs 350 and 352 are positioned in a carrying case 392. The barrier control transmitter 330 is positioned within the carrying case and the carrying case also includes a wireless communication device 390.

The switches S1 and S2, the LED 366, and user inputs 350 and 352 are protrude from the carrying case 392 such that a user can easily operate these controls. The wireless communication device 390 is separate and distinct from the transmitter 330. The barrier control transmitter 330 can be easily removed from the case so that upgrades or changes may be made to the transmitter. Conversely, an entire new transmitter may also be exchanged whenever the user desires.

The barrier control transmitter 330 of FIG. 6 may also be included in other accessories or integrated in some way with the wireless communication device 390. For example, the barrier control transmitter 330 may be integrated with the cover of a cover of the wireless communication device 390 or may be attached to a spare battery of the device. In any of these cases, the hardware and software of the barrier control transmitter 330 are separate and distinct from the hardware and software implementing the communication functions of the wireless communication device 390. The only potential sharing would be the battery, in the spare battery, could potentially power the transmitter.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

1. A communication system for transmitting and receiving wireless communications and controlling an access control device operator comprising:
a wireless communication portion comprising a wireless communication transmitter for providing wireless communications between a user at a communication device and a target communication device; and
an accessory portion connected to but functionally separate from the wireless communication transmitter, the accessory portion including a access control transmitter, the access control transmitter providing a signal to activate an access operator.

2. The system of claim 1 wherein the access control device is integral with the accessory portion.

3. The system of claim 1 wherein the wireless communication portion provides for cellular communications.

4. The system of claim 1 wherein the wireless communication portion facilitates push-to-talk services.

5. The system of claim 1 wherein the accessory portion is selected from a group comprised of a replacement cover, a replacement back, a replacement battery, a jacket and a glove.

6. The system of claim 1 wherein the transmitter includes an actuation button for initiating the transmission of a signal to the target communication device.

7. A system for use in a wireless network comprising:
a wireless communication device having wireless communication transmitter, for facilitating and providing communications between a first user and a second user; and
an access control transmitter, the access control transmitter integrated into a portion of the wireless communication device and providing a signal to actuate an access operator, the access transmitter having components to form a signal to actuate an access operator the access that are separate and distinct from the wireless communication transmitter of the wireless communication device.

8. The system of claim 7 wherein the wireless communication device includes a skin and the wireless communication device houses the transmitter is at least partially located within the skin.

9. The system of claim 7 wherein the wireless communication device is chosen from a group comprising a cellular phone, a walkie talkie, a personal digital assistant, and a personal computer having wireless access.

10. A system for transmitting and receiving wireless communications and controlling a barrier operator comprising:
a wireless communication device including:
a wireless communication portion comprising a wireless communication transmitter for providing wireless communications between a user at a communication device and a target communication device; and
an accessory portion connected to but functionally separate from the wireless communication transmitter, the accessory portion including an access control transmitter, the barrier control transmitter providing a signal to activate an access operator; and
an access operator, the access operator communicatively coupled to the access control transmitter and being actuated by the barrier control transmitter.

11. A method for controlling an access operator comprising:
associating a wireless communication transmitter with a mobile communication device, the transmitter associated with but functionally separate from the mobile communication device; and
actuating the access control transmitter in the accessory to operate an access operator.

12. The method of claim 11 wherein activating the access control transmitter comprises pressing a button on the transmitter.

13. The method of claim 11 wherein associating an access control transmitter comprises providing a transmitter in an accessory to a cellular telephone.

14. The method of claim 11 wherein associating an access control transmitter comprises providing a transmitter in an accessory for a push-to-talk device.

15. The method of claim 11 wherein associating an access control transmitter comprises integrating the access control transmitter with the mobile communication device.
